(19) United States
(12) Patent Application Publication
(10) Pub. No.: US 2015/0134938 A1
(43) Pub. Date: May 14, 2015

(54) IMAGE PROCESSING DEVICE, INSTRUCTION PROCESSING METHOD, AND COMPUTER PROGRAM PRODUCT

(71) Applicants: Tamotsu HOSONO, Kanagawa (JP); Takahiro Ide, Kanagawa (JP)

(72) Inventors: Tamotsu HOSONO, Kanagawa (JP); Takahiro Ide, Kanagawa (JP)

(21) Appl. No.: 14/537,068

(22) Filed: Nov. 10, 2014

(30) Foreign Application Priority Data
Nov. 14, 2013 (JP) 2013-236235

(51) Int. Cl. G06F 9/30; G06T 1/20

(52) U.S. Cl. CPC G06F 9/30145; G06T 1/20; G06T 2200/28
USPC 712/225

(57) ABSTRACT

An image processing device includes an operation unit and is able to receive a plurality of operation instructions in parallel from the operation unit and a portable information processing terminal. The image processing device includes: an instruction processing unit that executes processing according to the received operation instructions. The instruction processing unit, when the operation instruction is a predetermined instruction generated by an operation to the operation unit included in the image processing device, executes predetermined processing according to the predetermined instruction, when the operation instruction is a predetermined instruction generated by an operation to the information processing terminal, stores the predetermined instruction in a storage medium of the image processing device, and when the operation instruction is a processing execution permission instruction, executes the predetermined processing according to the predetermined instruction corresponding to the processing execution permission instruction among the predetermined instructions stored in the storage medium.

### CROSS-REFERENCE TO RELATED APPLICATIONS

The present application claims priority to and incorporates by reference the entire contents of Japanese Patent Application No. 2013-236235 filed in Japan on Nov. 14, 2013.

### BACKGROUND OF THE INVENTION

1. Field of the Invention

The present invention relates to an image processing device, an instruction processing method, and a computer program product.

2. Description of the Related Art

In recent years, digitization of information tends to be promoted and image processing devices, such as a printer and a facsimile that are used to output digitized information and a scanner that is used to digitize documents, are essential apparatuses. Such an image processing device is often formed as a Multi Function Peripheral (MFP) that can be used as a printer, a facsimile, a scanner, and a copier by including an image capturing function, an image forming function, and a communication function.

On the other hand, in recent years, mobile phones are highly sophisticated and portable information processing devices (hereinafter referred to as a “portable terminal”) such as a smartphone and a tablet terminal which have information processing functions similar to those of PC have become widely used. Such a portable terminal often includes a touch panel, a GPS function, a velocity sensor, and an interface of a wireless communication function, so that the portable terminal can be used for various uses depending on a software program. Therefore, it can be considered to use a portable terminal as a display panel for remotely controlling the aforementioned image processing device.

By using such portable terminals, a plurality of users can operate the image processing device in parallel through the display panels of their portable terminals. Further, at the same time, another user can operate the image processing device through a display panel fixed to the image processing device.

In order to improve operational convenience of a user, a method is proposed in which screens which are related to an operation of an image processing device and which are related to each other are displayed on respective operation panels of a portable terminal and the image processing device by causing the operation panel of the portable terminal that can communicate with the image processing device and the operation panel fixed to the image processing device to operate together (for example, see JP 2013-110470 A).

However, when a plurality of users operates an image processing device in parallel, there is a case in which a certain user who operates the image processing device through an operation panel fixed to the image processing device sees printed matter printed out by the image processing device according to a remote operation of another user through a portable terminal or the certain user takes away the printed matter along with his or her own printed matter, so that it is undesirable for security reasons.

On the other hand, in a technique disclosed in JP 2013-110470 A, it is not assumed that while a certain user operates the image processing device, another user also operates the image processing device, so that a problem for security reasons as described above is reduced. However, there is a limitation that a plurality of users cannot operate the image processing device in parallel.

In view of the above, there is a need to improve security of printed matter of an image processing device that can be operated by a plurality of users in parallel.

### SUMMARY OF THE INVENTION

It is an object of the present invention to at least partially solve the problems in the conventional technology.

An image processing device includes an operation unit and is able to receive a plurality of operation instructions in parallel from the operation unit and a portable information processing terminal. The image processing device includes: an instruction processing unit that executes processing according to the received operation instructions. The instruction processing unit, when the operation instruction is a predetermined instruction generated by an operation to the operation unit included in the image processing device, executes predetermined processing according to the predetermined instruction, when the operation instruction is a predetermined instruction generated by an operation to the information processing terminal, stores the predetermined instruction in a storage medium of the image processing device, and when the operation instruction is a processing execution permission instruction that permits predetermined processing, executes the predetermined processing according to the predetermined instruction corresponding to the processing execution permission instruction among the predetermined instructions stored in the storage medium.

An instruction processing method is of an image processing device that includes an operation unit and is able to receive a plurality of operation instructions in parallel from the operation unit and a portable information processing terminal. The instruction processing method includes: when the received operation instruction is a predetermined instruction generated by an operation to the operation unit included in the image processing device, executing predetermined processing according to the predetermined instruction; when the operation instruction is a predetermined instruction generated by an operation to the information processing terminal, storing the predetermined instruction in a storage medium of the image processing device; and when the operation instruction is a processing execution permission instruction that permits predetermined processing, executing the predetermined processing according to the predetermined instruction corresponding to the processing execution permission instruction among the predetermined instructions stored in the storage medium.

A computer program product includes a non-transitory computer-readable medium containing an instruction processing program of an image processing device that includes an operation unit and is able to receive a plurality of operation instructions in parallel from the operation unit and a portable information processing terminal. The instruction processing program causes a computer to perform: when the received operation instruction is a predetermined instruction generated by an operation to the operation unit included in the image processing device, executing predetermined processing according to the predetermined instruction; when the operation instruction is a predetermined instruction generated by an operation to the information processing terminal, storing the predetermined instruction in a storage medium of the image processing device; and when the operation instruction is a processing execution permission instruction that permits predetermined processing, executing the predetermined processing according to the predetermined instruction corresponding to the processing execution permission instruction among the predetermined instructions stored in the storage medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an operation form of a system according to an embodiment of the present invention;

FIG. 2 is a diagram schematically illustrating a hardware configuration of an information processing device according to the embodiment of the present invention;

FIG. 3 is a block diagram illustrating a functional configuration of an image processing device according to the embodiment of the present invention;

FIG. 4 is a block diagram illustrating a functional configuration of a mobile terminal according to the embodiment of the present invention;

FIG. 5 is a block diagram illustrating a functional configuration of a main control unit of the image processing device according to the embodiment of the present invention;

FIG. 6 is a diagram exemplifying a print job table stored in a print job storage unit according to the embodiment of the present invention;

FIG. 7 is a block diagram illustrating a functional configuration of a client application of the mobile terminal according to the embodiment of the present invention;

FIG. 8 is a flowchart illustrating instruction processing related to a print request performed by an instruction processing unit according to the present embodiment;

FIG. 9A and FIG. 9B are diagrams illustrating operation screens displayed on a display panel of the image processing device according to the present embodiment;

FIG. 10A and FIG. 10B are diagram illustrating operation screens displayed on an LCD of the mobile terminal according to the present embodiment;

FIG. 11 is a sequence diagram illustrating an operation when a print request is issued to the image processing device in the system according to the present embodiment;

FIG. 12 is a block diagram illustrating a functional configuration of a main control unit of an image processing device according to an embodiment of the present invention;

FIG. 13 is a diagram illustrating an operation screen with login information displayed on a mobile terminal according to the embodiment of the present invention; and

FIG. 14 is a diagram illustrating an operation screen with wait information displayed on the mobile terminal according to the embodiment of the present invention.

### DETAILED DESCRIPTION OF THE PREFERRED EMBODIMENTS

Hereinafter, embodiments of the present invention will be described in detail with reference to the drawings. In a present embodiment, a system will be described as an example in which an image processing device is operated through a mobile apparatus such as a smartphone and a tablet terminal and an operation panel fixed to the image processing device.

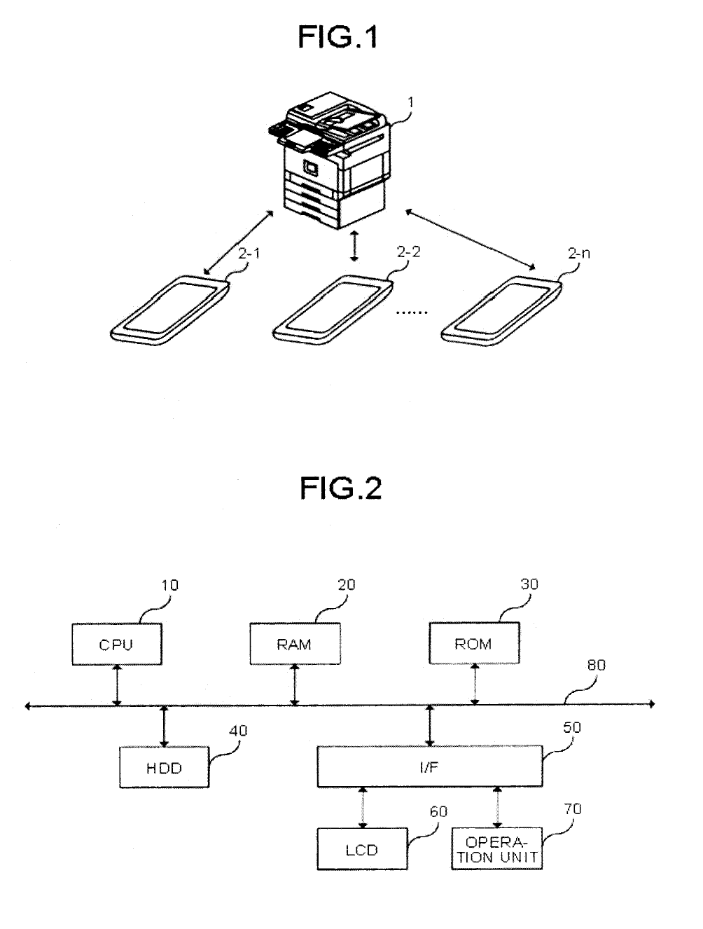

FIG. 1 is a diagram illustrating an operation form of an image processing system according to the present embodiment. As illustrated in FIG. 1, the image processing system according to the present embodiment is a control system of an image processing device, in which an image processing device 1 and n mobile terminals 2-1 to 2-n (n is an integer greater than or equal to 1) are communicably connected to each other. Hereinafter, the mobile terminals 2-1 to 2-n may be collectively referred to as a mobile terminal 2.

The image processing device 1 has an image capturing function, an image forming function, and a communication function, so that the image processing device 1 is a Multi Function Peripheral (MFP) that can be used as a printer, a facsimile, a scanner, and a copier. The mobile terminal 2 is a portable information processing terminal such as a smartphone, a tablet terminal, and a Personal Digital Assistant (PDA). The mobile terminal 2 according to the present embodiment is an information processing terminal controlled separately from the image processing device 1 and functions as an operation panel for operating the image processing device 1 by installing an application program provided by a maker that provides the image processing device 1 or a third party in the image processing device 1.

Next, hardware that constitutes an information processing device of the image processing device 1 and the mobile terminal 2 included in the image processing system according to the present embodiment will be described. FIG. 2 is a diagram illustrating a hardware configuration of the information processing device according to the present embodiment. As illustrated in FIG. 2, the information processing device according to the present embodiment includes the same configuration as that of a general server, Personal Computer (PC), or the like.

Specifically, in the information processing device according to the present embodiment, a Central Processing Unit (CPU) 10, a Random Access Memory (RAM) 20, a Read Only Memory (ROM) 30, a Hard Disk Drive (HDD) 40, and an I/F 50 are connected through a bus 80. Further, a Liquid Crystal Display (LCD) 60 and an operation unit 70 are connected to the I/F 50. In the case of the image processing device 1, an engine that executes image forming output and scanning is included.

The CPU 10 is a calculation unit, which controls operation of the entire information processing device. The RAM 20 is a volatile storage medium where information can be read and written very quickly and which is used as a work area when the CPU 10 processes information. The ROM 30 is a read-only non-volatile storage medium, in which a program such as firmware is stored. The HDD 40 is a non-volatile storage medium where information can be read and written and in which an Operating System (OS) and various control programs and application programs are stored. Besides the HDD, a semiconductor storage device such as a Solid State Drive (SSD) may be used.

The I/F 50 connects the bus 80 with various hardware and a network, and controls the various hardware and the network. The LCD 60 is a visual user interface for a user to check the state of the information processing device. The operation unit 70 is a user interface for a user to input information into the information processing device, and the operation unit 70 includes, for example, a keyboard, a mouse, various hardware buttons, and a touch panel. In the system according to the present embodiment, the mobile terminal 2 functions as the operation panel of the image processing device 1. Therefore, it is possible to omit the user interfaces such as the LCD 60 and the operation unit 70 which are directly connected to the image processing device 1.

In the hardware configuration as described above, programs stored in a storage medium such as the ROM 30, the HDD 40, or an optical disk not illustrated are read into the RAM 20 and the CPU 10 performs calculation according to the programs, so that a software control unit is constructed. Functional blocks that realize functions of each apparatus included in the image processing system according to the present embodiment are constructed by a combination of the software control unit constructed in this way and the hardware.

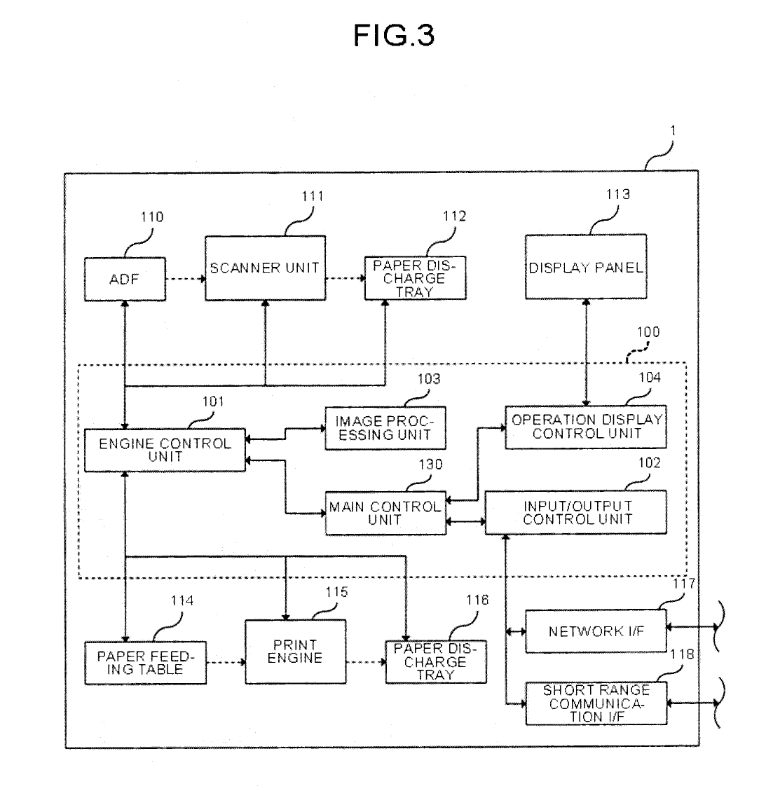

Next, functions of the image processing device 1 according to the present embodiment will be described. FIG. 3 is a diagram illustrating a functional configuration of the image processing device 1 according to the present embodiment. As illustrated in FIG. 3, the image processing device 1 according to the present embodiment includes a controller 100, an Auto Document Feeder (ADF) 110, a scanner unit 111, a paper discharge tray 112, a display panel 113, a paper feeding table 114, a print engine 115, a paper discharge tray 116, a network I/F 117, and a short range communication I/F 118.

The controller 100 includes a main control unit 130, an engine control unit 101, an input/output control unit 102, an image processing unit 103, and an operation display control unit 104. As illustrated in FIG. 3, the image processing device 1 according to the present embodiment is constructed as a MFP including the scanner unit 111 and the print engine 115. In FIG. 3, an electrical connection is indicated by a solid arrow and the flow of a sheet of paper is indicated by a dashed arrow.

The display panel 113 is an output interface that visually displays a state of the image processing device 1 as well as an input interface (operation unit) as a touch panel for a user to directly operate the image processing device 1 or input information into the image processing device 1. The network I/F 117 is an interface for the image processing device 1 to communicate with another apparatus such as an administrator terminal through a network, and Ethernet (registered trademark) and/or a USE interface are used as the network I/F 117.

The short range communication I/F 118 is an interface for the image processing device 1 to communicate with another apparatus by short range radio communication, and an interface such as Bluetooth (registered trademark), Wireless Fidelity (Wi-Fi), and FeliCa (registered trademark) is used as the short range communication I/F 118.

The controller 100 is constructed by a combination of software and hardware. Specifically, control programs such as firmware stored in a non-volatile storage medium such as the ROM 30 and the HDD 40 are loaded into the RAM 20 and the controller 100 is constructed by a software control unit constructed by the CPU 10 performing calculation according to these programs and hardware such as an integrated circuit. The controller 100 functions as a control unit that controls the entire image processing device 1.

The main control unit 130 plays a role of controlling each unit included in the controller 100 and gives an instruction to each unit of the controller 100. The engine control unit 101 serves as a drive unit that controls or drives the print engine 115 and the scanner unit 111. The input/output control unit 102 inputs a signal and an instruction that are inputted through the network I/F 117 or the short range communication I/F 118 into the main control unit 130. The main control unit 130 controls the input/output control unit 102 and accesses another device though the network I/F 117 or the short range communication I/F 118.

The image processing unit 103 generates drawing information based on image information to be printed out according to the control of the main control unit 130. The drawing information is information to draw an image to be formed by the print engine 115, which is an image forming unit, in an image forming operation. The image processing unit 103 processes captured image data inputted from the scanner unit 111 and generates image data. The image data is information which is stored in the image processing device 1 or transmitted to another apparatus through the network I/F 117 or the short range communication I/F 118 as a result of the scanner operation. The operation display control unit 104 displays information on the display panel 113 or notifies the main control unit 130 of information inputted through the display panel 113.

In the case of an image processing device that has only a printer function, the ADF 110, the scanner unit 111, and the paper discharge tray 112 illustrated in FIG. 3 are omitted and functions to control the ADF 110, the scanner unit 111, and the paper discharge tray 112 are omitted from the functions of the engine control unit 101.

When the image processing device 1 operates as a printer, first, the input/output control unit 102 receives a print job through the network I/F 117. The input/output control unit 102 transfers the received print job to the main control unit 130. When the main control unit 130 receives the print job, the main control unit 130 controls the image processing unit 103 to generate drawing information based on document information or image information included in the print job. When the drawing information is generated by the image processing unit 103, the engine control unit 101 executes image forming on a sheet of paper conveyed from the paper feeding table 114 based on the generated drawing information. As a specific aspect of the print engine 115, an image forming mechanism of an ink jet method, an image forming mechanism of an electrophotographic method, and the like can be used. A document on which an image is formed by the print engine 115 is discharged to the paper discharge tray 116.

When the image processing device 1 operates as a scanner, the operation display control unit 104 or the input/output control unit 102 transfers a scan execution signal to the main control unit 130 according to an operation on the display panel 113 by a user or a scan execution instruction inputted from an external apparatus through the network I/F 117. The main control unit 130 controls the engine control unit 101 based on the received scan execution signal. The engine control unit 101 drives the ADF 110 and conveys a document which is set in the ADF 110 and from which an image will be captured, to the scanner unit 111. The engine control unit 101 drives the scanner unit 111 and captures the image of the document conveyed from the ADF 110. When no document is set in the ADF 110 and a document is directly set in the scanner unit 111, the scanner unit 111 captures an image of the set document according to control of the engine control unit 101. In other words, the scanner unit 111 operates as an image capturing unit.

In the image capturing operation, an image capturing element such as a CCD included in the scanner unit 111 optically scans the document, so that captured image information based on optical information is generated. The engine control unit 101 transfers the captured image information generated by the scanner unit 111 to the image processing unit 103. The image processing unit 103 generates image information based on the captured image information received from the engine control unit 101 according to the control of the main control unit 130. The image information generated by the image processing unit 103 is stored in a storage medium such as the HDD 40 mounted in the image processing device 1. The image information generated by the image processing unit 103 is stored in the HDD 40 or the like without change or transmitted to an external device by the input/output control unit. 102 through the network I/F 117 or the short range communication I/F 118 according to an instruction of a user.

When the image processing device 1 operates as a copier, the image processing unit 103 generates drawing information based on captured image information which the engine control unit. 101 receives from the scanner unit 111 or image information generated by the image processing unit 103. The engine control unit 101 drives the print engine 115 based on the drawing information in a manner similar to that in the printer operation.

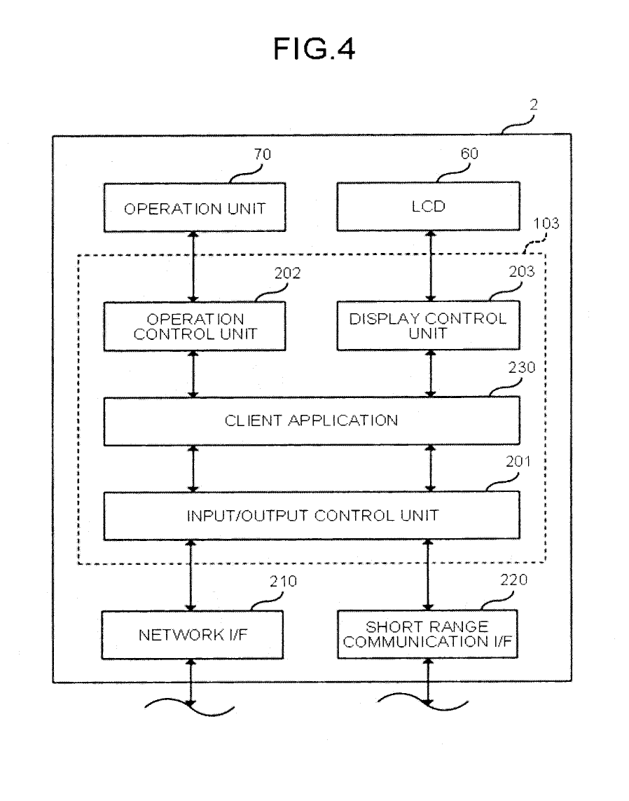

Next, a functional configuration of the mobile terminal 2 according to the present embodiment will be described with reference to FIG. 4. As illustrated in FIG. 4, the mobile terminal 2 according to the present embodiment includes a controller 200, a network I/F 210, and a short range communication I/F 220 in addition to the LCD 60 and the operation unit 70 described in FIG. 2. The controller 200 includes an input/output control unit 201, an operation control unit 202, a display control unit 203, and a client application 230.

The network I/F 210 is an interface for the mobile terminal 2 to communicate with another apparatus through a network, and an interface such as Ethernet (registered trademark) is used as the network I/F 210. The short range communication I/F 220 is an interface for the mobile terminal 2 to communicate with another apparatus by short range radio communication, and an interface such as Bluetooth (registered trademark), Wireless Fidelity (Wi-Fi), and FeliCa (registered trademark) is used as the short range communication I/F 220. The network I/F 210 and the short range communication I/F 220 are realized by the I/F 50 illustrated in FIG. 2.

The controller 200 is constructed by a combination of software and hardware. The controller 200 is a control unit that controls the entire mobile terminal 2. The input/output control unit 201 acquires information inputted through the network I/F 210 and transmits information to another apparatus through the network I/F 210. Further, the network I/F 210 acquires information inputted through the short range communication I/F 220 and transmits information to another apparatus through the short range communication I/F 220.

The operation control unit 202 acquires a signal of operation content which a user performs on the operation unit 70 and inputs the operation content into a module such as the client application 230 running on the mobile terminal 2. The display control unit 203 causes the LCD 60 to display a state of the mobile terminal 2, such as a Graphical User Interface (GUI) of the client application 230.

The client application 230 is constructed by a software program which is installed and operates in the mobile terminal 2 in order to use the function of the image processing system according to the present embodiment in the mobile terminal 2. The client application 230 realizes a function to receive an operation instruction for the image processing device 1 through the operation unit 70 of the mobile terminal 2, a function to transmit the received operation instruction to the image processing device 1 and cause the LCD 60 to display a screen according to the operation instruction, and/or the like.

In the system configuration as described above, the image processing device 1 according to the present embodiment is characterized in that, when the operation instruction received by the image processing device 1 through the display panel 113 which is a fixed operation unit fixed to the image processing device 1 and the operation unit 70 of the mobile terminal 2 is a print request, the image processing device 1 performs processing according to the type of the operation unit that issues the print request. As a configuration according to the present embodiment, first, a functional configuration related to the processing according to the type of the operation unit in the main control unit 130 according to the present embodiment will be described.

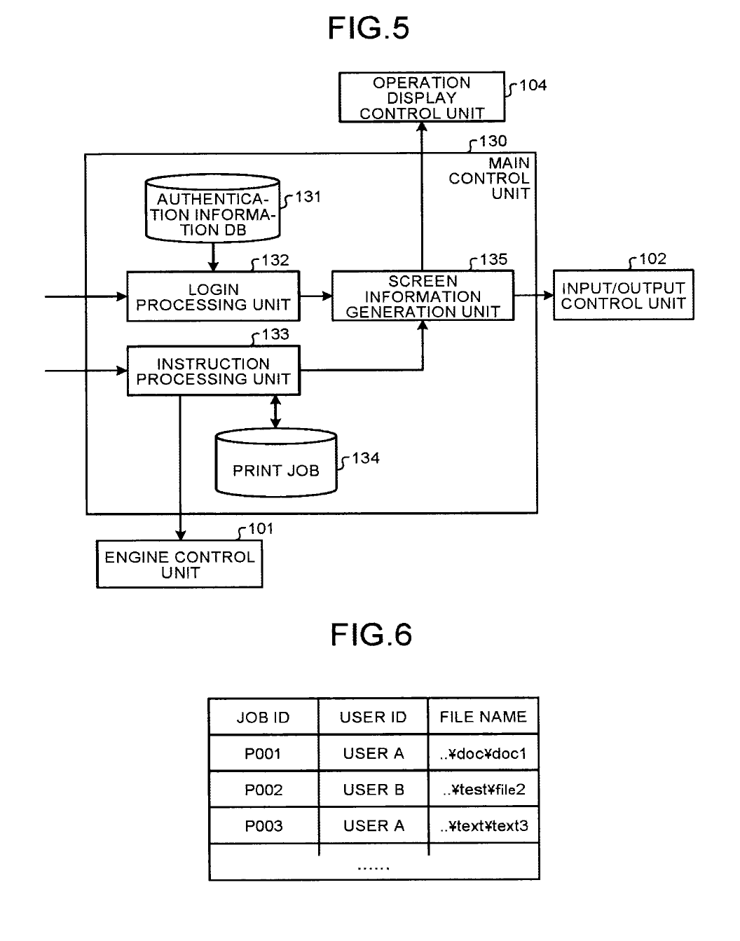

FIG. 5 is a block diagram exemplifying the functional configuration related to the processing according to the type of the operation unit in the main control unit 130 according to the present embodiment. As illustrated in FIG. 5, the main control unit 130 according to the present embodiment includes an authentication information DB 131, a login processing unit 132, an instruction processing unit 133, a print job storage unit 134, and a screen information generation unit 135.

The authentication information DB 131 stores authentication information used for login authentication of each user. The authentication information is, for example, information in which a user ID indicating identification information for uniquely identifying each user is associated with a password that authenticates the user. The login processing unit 132 performs login authentication of a user based on inputted user information and the authentication information stored in the authentication information DB 131. The user information includes, for example, a user ID, a password, and a terminal ID for identifying a terminal that outputs the user information.

Specifically, the login processing unit 132 acquires a password corresponding to the user ID included in the inputted user information from the authentication information DB 131, and when the acquired password and the password included in the user information correspond with each other, the login processing unit 132 authenticates the login of the user. Further, the login processing unit 132 outputs the user information of the user whose login is authenticated to the screen information generation unit 135.

When the instruction processing unit 133 receives inputted instruction information, the instruction processing unit 133 executes processing for the image processing device 1 according to the received instruction information through the engine control unit 101. The instruction information includes, for example, an operation instruction such as a print request based on a print job, a copy start request, and a scan start request, a user ID of a user who requests the operation instruction, and a terminal ID of a terminal that requests the operation instruction. The instruction processing unit 133 executes the above processing and outputs processing information indicating a state of the processing (printing, print completion, and the like) and the terminal ID included in the instruction information to the screen information generation unit 135.

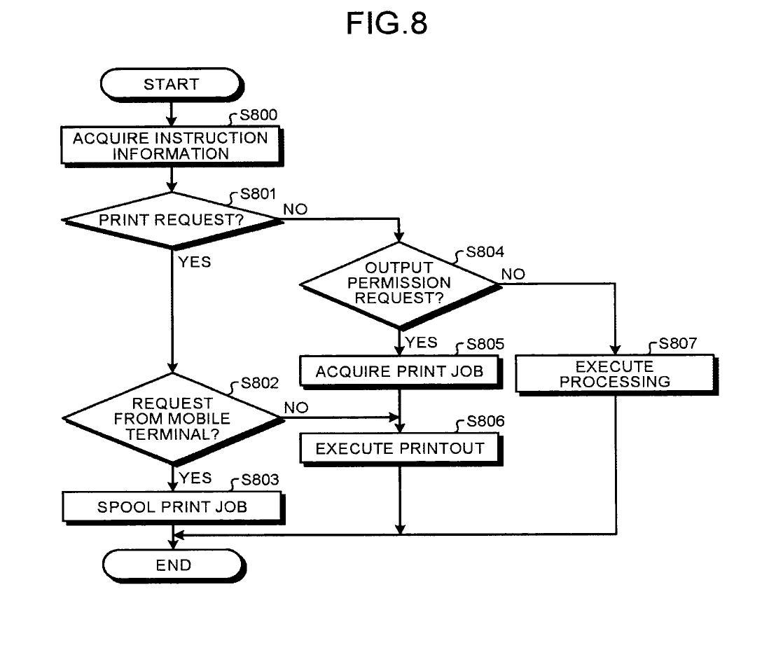

When the operation instruction included in the inputted instruction information is a print request based on a print job, the instruction processing unit 133 executes printout processing to a sheet of paper or the like based on the print job or storage processing of the print job into the print job storage unit 134 according to the type of the terminal that outputs the operation instruction. When the operation instruction included in the inputted instruction information is an output permission request (output permission instruction) that permits printout to a recording medium such as a sheet of paper, the instruction processing unit 133 executes printout processing to a sheet of paper or the like based on the print job stored in the print job storage unit 134. The detailed processing of the instruction processing unit 133 will be described later with reference to FIG. 8.

The print job storage unit 134 is a storage medium that stores a print job inputted from the instruction processing unit 133. The print job includes, for example, a job ID that identifies the print job and a file name of a file to be printed. FIG. 6 is a diagram exemplifying a print job table stored in the print job storage unit 134. As illustrated in FIG. 6, in the print job table, the job ID, the user ID, and the file name which are included in the print job are stored for each print job. Although the user ID stored in the print job table can be acquired from the instruction information inputted into the instruction processing unit 133, the user ID may be included in the print job.

The screen information generation unit 135 generates operation screen information to cause a terminal to display an operation screen for performing an operation directed to the image processing device 1 and transmits the operation screen information to a terminal identified by the terminal ID included in the user information inputted from the login processing unit 132. For example, when the identified terminal is the mobile terminal 2-1, the screen information generation unit 135 transmits the generated operation screen information to the mobile terminal 2-1 through the input/output control unit 102.

For example, when the identified terminal is the image processing device 1 itself, the screen information generation unit 135 transmits an operation screen based on the generated operation screen information through the operation display control unit 104 and causes the display panel 113, which is an operation panel fixed to the image processing device 1, to display the operation screen.

Further, the screen information generation unit 135 generates screen information according to the state of the processing indicated by the processing information inputted from the instruction processing unit 133 and transmits the screen information to a terminal identified by the terminal ID inputted from the instruction processing unit 133. For example, when the processing information inputted from the instruction processing unit 133 indicates the print completion and the terminal identified by the terminal ID is the mobile terminal 2-1, the screen information generation unit 135 generates screen information indicating the print completion and transmits the screen information to the mobile terminal 2-1 through the input/output control unit 102. For example, when the processing information inputted from the instruction processing unit 133 indicates the printing and the terminal identified by the terminal ID is the image processing device 1 itself, the screen information generation unit 135 generates screen information indicating the printing and causes the display panel 113 to display the screen information through the operation display control unit 104.

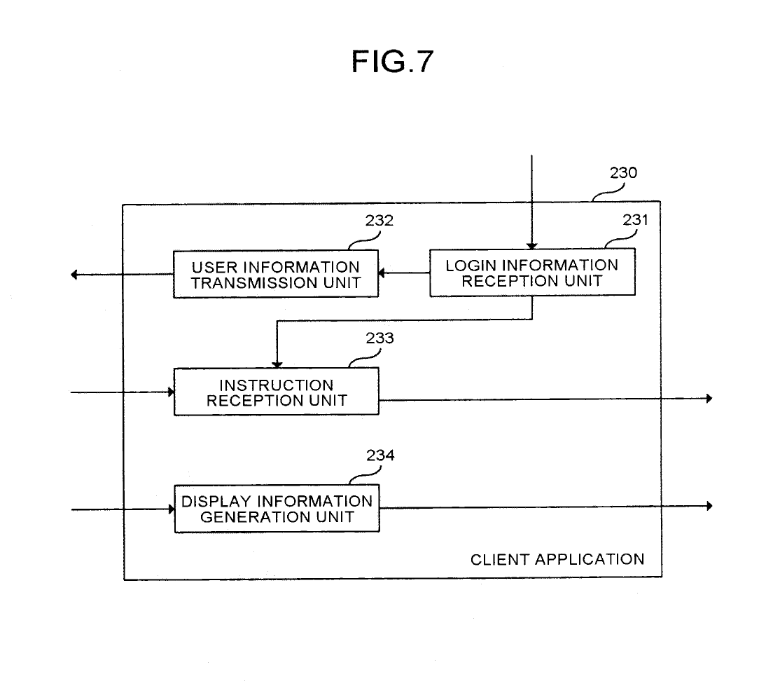

Next, a functional configuration of the client application 230 according to the present embodiment will be described. FIG. 7 is a block diagram exemplifying the functional configuration of the client application 230 according to the present embodiment. As illustrated in FIG. 7, the client application 230 according to the present embodiment includes a login information reception unit 231, a user information transmission unit 232, an instruction reception unit 233, and a display information generation unit 234.

The login information reception unit 231 receives a user ID and a password inputted through a login screen displayed on the LCD 60 of the mobile terminal 2 by, for example, starting a dedicated application for operating the image processing device 1 on the mobile terminal 2 and outputs the user ID and the password to the user information transmission unit 232 as login information. Further, the login information reception unit 231 outputs the received user ID to the instruction reception unit 233.

The user information transmission unit 232 transmits the login information inputted from the login information reception unit 231 and user information including the terminal ID of the mobile terminal 2 to the login processing unit 132 through the network I/F 210 by control of the input/output control unit 201. It is assumed that the terminal ID transmitted by the user information transmission unit 232 is stored in advance in a storage medium such as, the ROM 30 and the HDD 40 of the mobile terminal 2.

The instruction reception unit 233 receives various operation instructions from a user through an operation screen displayed on the LCD 60 and outputs instruction information including the received operation instructions, the user ID inputted from the login information reception unit 231, and the terminal ID to the instruction processing unit 133.

The display information generation unit 234 generates display information of the operation screen based on the operation screen information inputted from the screen information generation unit 135 and outputs the display information to the display control unit 203. Further, the display information generation unit 234 generates display information of an execution screen when an operation according to an operation instruction of a user received by the instruction reception unit 233 is executed on the basis of the screen information inputted from the screen information generation unit 135 and outputs the display information to the display control unit 203.

The operation instruction is not only received through the operation screen displayed on the LCD 60 of the mobile terminal 2, but also received through the operation screen displayed on the display panel 113 of the image processing device 1. In this case, instruction information including the operation instruction received through the display panel 113, the user ID with which login has been performed through the login screen displayed on the display panel 113 of the image processing device 1, and the terminal ID of the image processing device 1 is outputted to the main control unit 130 through the operation display control unit 104.

Next, regarding the instruction processing performed by the instruction processing unit 133 described in FIG. 5, details of instruction processing related to the print request according to the present embodiment will be described. FIG. 8 is a flowchart exemplifying the instruction processing related to the print request performed by the instruction processing unit 133 according to the present embodiment. As illustrated in FIG. 8, the instruction processing unit 133 acquires instruction information transmitted from a terminal that receives an operation instruction (S800).

When the operation instruction included in the acquired instruction information is a print request based on a print job (S801/YES), the instruction processing unit 133 determines whether or not the print request is requested through the operation screen displayed on the mobile terminal 2 (S802). In other words, the instruction processing unit 133 determines whether or not the type of the terminal identified by the terminal ID included in the acquired instruction information is the mobile terminal 2.

When the print request is requested through the operation screen displayed on the mobile terminal 2 (S802/YES), the instruction processing unit 133 stores the print job requested to be printed in the print job storage unit 134 (S803). In other words, the print job requested to be printed is spooled in the image processing device 1 and printout is not performed on a sheet of paper or the like based on the print job at this stage. On the other hand, when the print request is issued through the operation screen displayed on the display panel 113 of the image processing device 1 (S802/NO), the instruction processing unit 133 executes printout onto a sheet of paper or the like based on the print job requested to be printed (S806).

The print job is included in, for example, the instruction information as an image forming output instruction generated by the mobile terminal 2 that issues the print request and transmitted to the image processing device 1 (or the print job is transmitted to the image processing device 1 along with the instruction information). In this case, the terminal ID of the mobile terminal 2 that generates the print job may be included in the generated print job. In addition, the print job may be generated as an image forming output instruction in the image processing device according to the print request included in the instruction information. In this case, the terminal ID of the mobile terminal 2 included in the instruction information may be included in the generated print job.

On the other hand, when the operation instruction included in the acquired instruction information is an output permission request (S804/YES), the instruction processing unit 133 acquires a print job specified in the output permission request from among the print jobs stored in the print job storage unit 134 (S805). The instruction processing unit 133 that acquires the print job executes printout onto a sheet of paper or the like on the basis of the acquired print job (S806).

On the other hand, when the operation instruction included in the acquired instruction information is neither the print request nor the output permission request (S801/NO, S804/NO), the instruction processing unit 133 executes processing according to the operation instruction (S807). The processing according to the operation instruction includes processing to acquire a print job requested to be printed by a user who issues a spool job list request that requests a list of spooled print jobs and output the print job to the screen information generation unit 135 in addition to copy processing and scanner processing.

The output permission request is a request to permit printout of a print job stored in the print job storage unit 134, that is, a print job which is not yet printed out on a sheet of paper or the like, and the output permission request may be requested through either one of the respective operation screens displayed on the image processing device 1 and the mobile terminal 2. Hereinafter, a specific operation screen will be indicated and described.

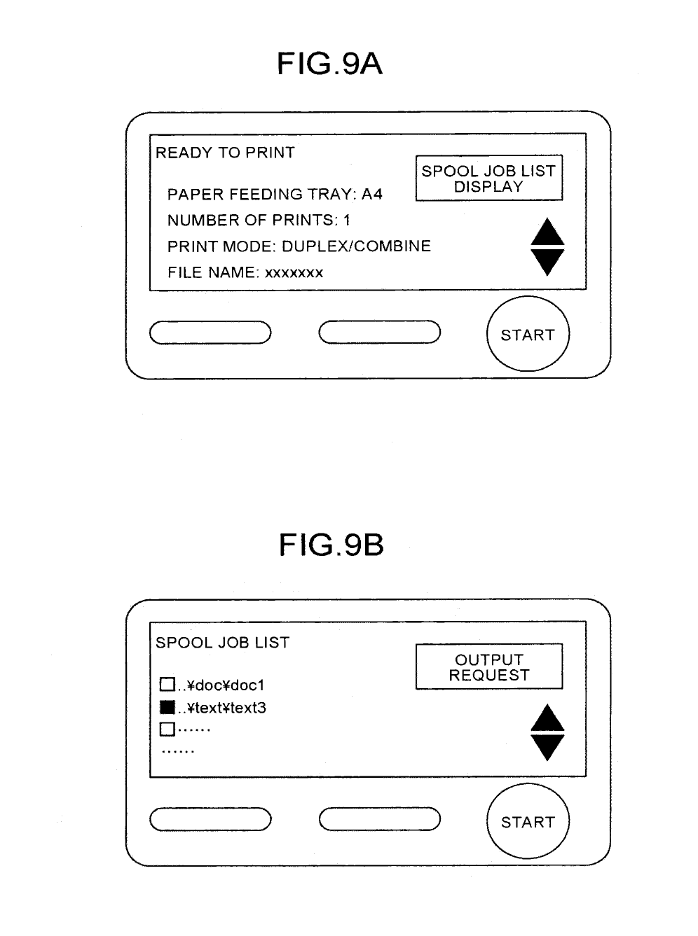

FIG. 9A and FIG. 9B are diagrams exemplifying operation screens displayed on the display panel 113 of the image processing device 1. FIG. 9A is a diagram exemplifying an operation screen displayed on the display panel 113 when a user who issues a print request from the operation screen of the mobile terminal 2 logs in through the operation screen of the image processing device 1. Here, when a “spool job list display” button illustrated in FIG. 9A is pressed, as illustrated in FIG. 9B, a spool job list screen that shows a list of print jobs which are requested to be printed by the user who logs in and spooled (stored in the print job storage unit 134) is displayed.

When a print job for which output is to be permitted is selected from among the print jobs displayed on the spool job list screen illustrated in FIG. 9B and an “output request” button is pressed, instruction information including an output permission request is transmitted to the instruction processing unit 133. For example, in the case illustrated in FIG. 9B, a printout based on a print job corresponding to a file name “ . . . ¥text¥text3” having checkbox filled with black color is requested. In other words, the “output request” button is an instruction generation unit that generates an output permission instruction.

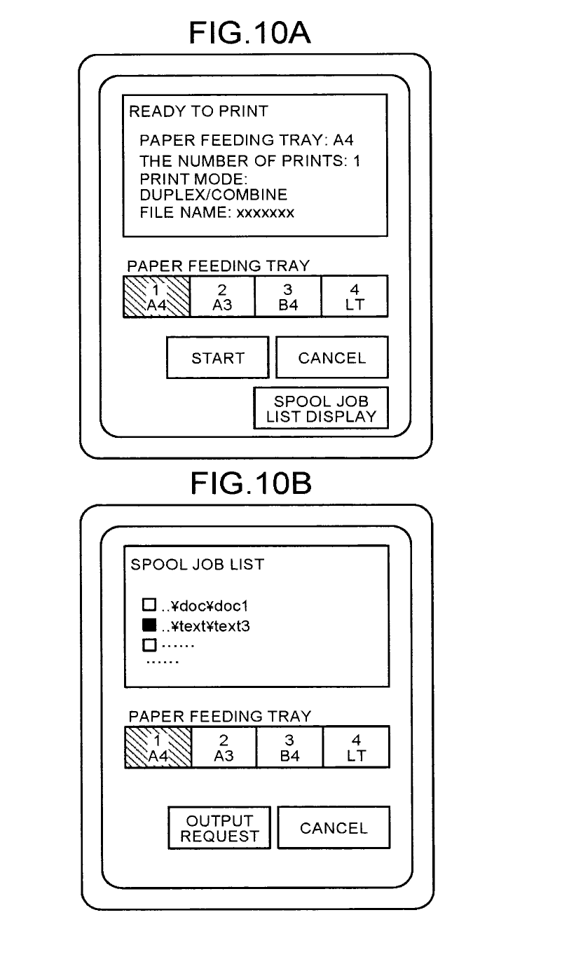

FIG. 10A and FIG. 10B are diagrams exemplifying operation screens displayed on the LCD 60 of the mobile terminal 2. FIG. 10A is a diagram exemplifying an operation screen displayed on the mobile terminal 2 that issues a print request. Here, when a “spool job list display” button illustrated in FIG. 10A is pressed, as illustrated in FIG. 10B, a spool job list screen that shows a list of print jobs which are requested to be printed by a user who logs in to the mobile terminal 2 and spooled is displayed.

In the same manner as in the case described in FIG. 9B, when a print job for which output is to be permitted is selected from among the print jobs displayed on the spool job list screen illustrated in FIG. 10B and an “output request” button is pressed, instruction information including an output permission request is transmitted from the instruction reception unit 233 to the instruction processing unit 133.

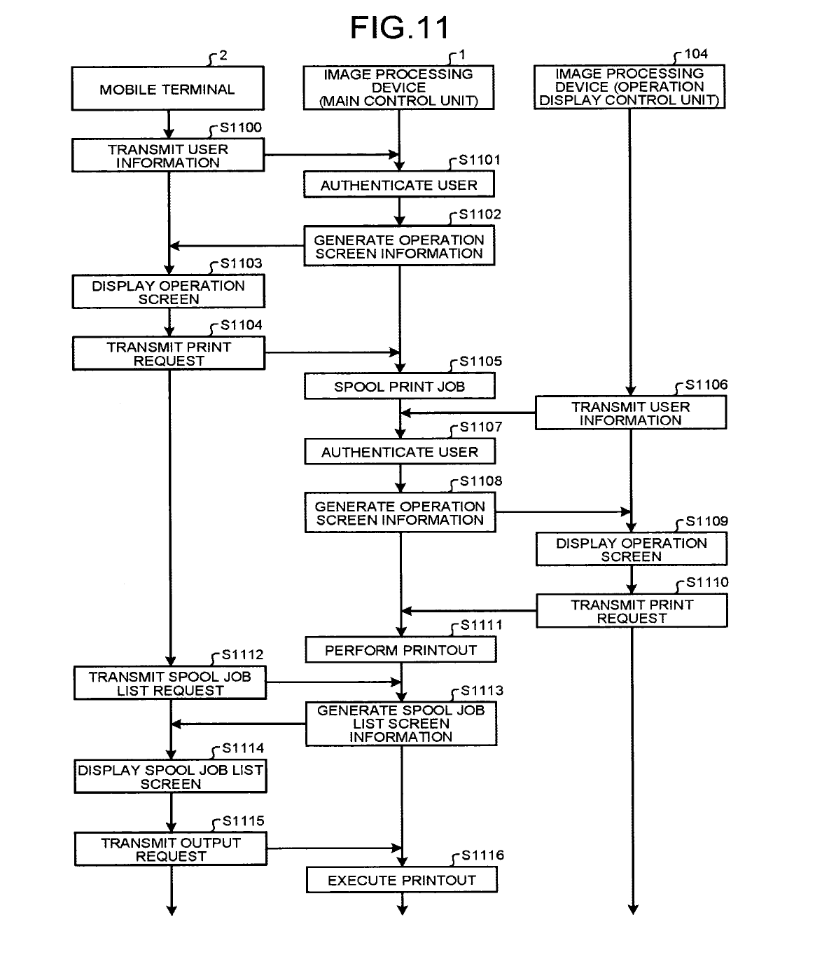

Next, an operation will be described in which a print request is issued to the image processing device 1 through an operation screen displayed on the display panel 113 of the image processing device 1 or the LCD 60 of the mobile terminal 2 in the system according to the present embodiment. FIG. 11 is a sequence diagram exemplifying the aforementioned operation in the system according to the present embodiment.

In the present description, a case in which one mobile terminal 2 can be used in the system is described as an example. However, two or more mobile terminals 2 may be included. In FIG. 11, to clarify the description, the image processing device 1 (main control unit 130) used as a component to perform processing for a print request and the image processing device 1 (operation display control unit 104) used as a component to perform operation control through the display panel 113 fixed to the image processing device 1 and display control on the display panel 113 are distinctively illustrated.

As illustrated in FIG. 11, the mobile terminal 2 transmits user information of a user who uses the mobile terminal 2 to the image processing device 1 (S1100). The image processing device 1 that receives the user information from the mobile terminal 2 performs login authentication of the user (S1101). When the login authentication of the user is successfully performed, the image processing device 1 generates operation screen information and outputs the operation screen information to the mobile terminal 2 (S1102).

The mobile terminal 2 that acquires the operation screen information generated by the image processing device 1 generates display information of an operation screen based on the acquired operation screen information, and displays the operation screen as illustrated in FIG. 10A on the LCD 60 of the mobile terminal 2 (S1103). When the user issues a print request through the displayed operation screen, the mobile terminal 2 transmits the print request to the image processing device 1 (S1104). For example, in the operation screen illustrated in FIG. 10A, when the user selects a file to be printed out and presses the “start” button, the mobile terminal 2 transmits a print request based on a print job including print setting illustrated in FIG. 10A to the image processing device 1.

The print request received by the image processing device 1 is transmitted from the mobile terminal 2, so that the image processing device 1 that receives the print request does not perform printout based on the print job corresponding to the received print request at this stage and spools the print job (S1105).

On the other hand, the operation display control unit 104 transmits user information of a user who operates through the display panel 113 of the image processing device 1 to the image processing device 1 (S1106). The image processing device 1 that receives the user information from the operation display control unit 104 performs login authentication of the user (S1107). When the login authentication of the user is successfully performed, the image processing device 1 generates operation screen information and outputs the operation screen information to the operation display control unit 104 (S1108).

The operation display control unit 104 that acquires the operation screen information generated by the image processing device 1 generates display information of an operation screen based on the acquired operation screen information, and displays the operation screen as illustrated in FIG. 9A on the display panel 113 of the image processing device 1 (S1109). When the user issues a print request through the displayed operation screen, the operation display control unit 104 transmits the print request to the image processing device 1 (S1110). For example, in the operation screen illustrated in FIG. 9A, when the user selects a file to be printed out and presses the “start” button, the operation display control unit 104 transmits a print request based on a print job including print setting illustrated in FIG. 9A to the image processing device 1.

The print request received by the image processing device 1 is transmitted from the operation display control unit 104, that is, the image processing device 1 itself, so that the image processing device 1 that receives the print request executes printout based on the print job corresponding to the received print request (S1111).

On the other hand, when the “spool job list display” button is pressed on the operation screen illustrated in FIG. 10A, the mobile terminal 2 transmits a spool job list request to the image processing device 1 (S1112). The image processing device 1 that receives the spool job list request acquires print jobs including the user ID of the user who issues the spool job list request from the spooled print jobs (that is, the print jobs stored in the print job storage unit 134), generates spool job list screen information, and outputs the spool job list screen information to the mobile terminal 2 (S1113).

For example, when the print jobs illustrated in FIG. 6 are stored in the print job storage unit 134 and the user ID of the user who issues the spool job list request is “user A”, the image processing device 1 acquires the print jobs of the job IDs “P001” and “P003” as the spool jobs. Then, the image processing device 1 generates spool job list screen information of the acquired print jobs and outputs the spool job list screen information to the mobile terminal 2.

The mobile terminal 2 that acquires the spool job list screen information generated by the image processing device 1 generates display information of an spool job list screen based on the acquired screen information, and displays the operation screen as illustrated in FIG. 10B on the LCD 60 of the mobile terminal 2 (S1114). When a print job for which printout is to be permitted is selected from the spool job list screen through the operation screen illustrated in FIG. 10B and an “output request” button is pressed, the mobile terminal 2 transmits an output permission request based on the specified print job to the image processing device 1 (S1115).

The image processing device 1 that receives the output permission request from the mobile terminal 2 executes printout based on the print job specified in the received output permission request (S1116). The time relations between the times when respective operations illustrated in FIG. 11 are performed is not limited to those illustrated in FIG. 11. For example, the operations performed by the operation display control unit 104 may be performed earlier than the operations performed by the mobile terminal 2, and the spool job list request may be issued by the mobile terminal 2 earlier than the operations performed by the operation display control unit 104.

As described above, in the present embodiment, when a print request is issued from the terminal including an operation panel where operations directed to the image processing device 1 are performed, if a print request is issued from the mobile terminal 2 that remotely performs operations directed to the image processing device 1, the image processing device 1 does not execute printout onto a sheet of paper or the like based on the print job corresponding to the print request, but temporarily spools the print job in the image processing device 1, and if a print request is issued from the operation panel fixed to the image processing device 1, the image processing device 1 executes printout onto a sheet of paper or the like based on the print job corresponding to the print request. When the image processing device 1 receives an output permission request transmitted through an operation screen displayed on the mobile terminal 2 or the display panel 113, the image processing device 1 executes printout onto a sheet of paper or the like based on the print job specified in the output permission request among the spooled print jobs.

Thereby, regarding a print job requested by a certain user A from a location away from the image processing device 1, printout onto a sheet of paper or the like is not executed and the print job is spooled in the image processing device 1, so that it is possible to prevent printed matter requested by the user A from being seen by another user B who uses the operation panel fixed to the image processing device 1. When the user A performs the operation of the output permission request in a state in which the user A is close to the image processing device 1 and can quickly take the outputted printed matter, the printout onto a sheet of paper or the like based on the spooled print job is executed, so that the security of the printed matter tends to be ensured. On the other hand, regarding a print job requested from the operation panel fixed to the image processing device 1, even when the printout onto a sheet of paper or the like is instantly executed, the chances that the printed matter is seen by another user are low, so that the security of the printed matter is ensured. Therefore, according to the present invention, it is possible to improve security of printed matter of the image processing device that can be operated by a plurality of users in parallel.

In the embodiment described above, as an example, it is described that, when an output permission request is issued through an operation screen displayed on the display panel 113 or the mobile terminal 2, the printout onto a sheet of paper or the like based on a print job spooled in the image processing device 1 is executed. However, this is an example, and when the image processing device 1 determines that the mobile terminal 2 is within a predetermined range from the image processing device 1 by, for example, receiving position information transmitted from the mobile terminal 2, the image processing device 1 transmits a notification for checking whether or not to perform output processing to the mobile terminal 2, and when the mobile terminal 2 that receives the notification transmits an output permission request, the image processing device 1 may execute printout based on the spooled print job. In this case, the image processing device 1 may execute printout based on a print job, which is requested to be printed from the mobile terminal 2 located within the predetermined range and spooled, without transmitting the notification for checking.

In addition, when the mobile terminal 2 that transmits the print request is brought close to a Felica reader of the image processing device 1 and the user information is transmitted through a Felica interface that is used as the short range communication I/F 220, the image processing device 1 may execute printout based on a spool job corresponding to the user ID included in the user information. Further, in this case, login processing is performed in the image processing device 1 based on the transmitted user information, a list of jobs spooled by the user who logs in is displayed on the operation screen displayed on the display panel 113, and an output request may be issued from this screen.

Further, in the embodiment described above, a case is described as an example in which a user selects a print job that is to be permitted to be outputted from the spool job list screen and an output permission request based on the selected print job is issued. However, this is an example, and when an output permission request is issued, printout based on all print jobs which are requested to be printed and spooled by the user who issues the output permission request may be executed.

Further, in the embodiment described above, a case is described as an example in which all print jobs requested to be printed from the mobile terminal 2 are temporarily spooled in the image processing device 1 until an output permission request is issued. In addition, even when the print request is issued from the mobile terminal 2, when the print request is issued by specifying a document with no security problem even if other users see the document, the print job of the specified document may be printed out without being spooled. Alternatively, when the distance between the mobile terminal 2 that issues the print request and the image processing device 1 is within a predetermined range, the user who issues the print request from the mobile terminal 2 can quickly collect the printed matter, so that the print job corresponding to the print request may be printed out without being spooled.

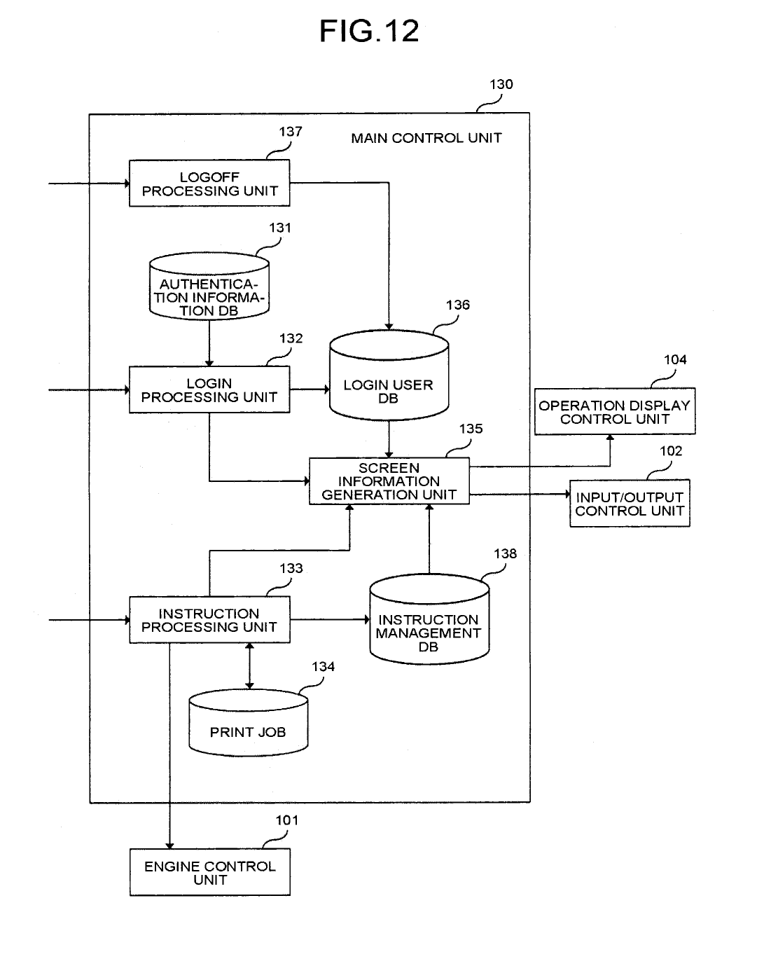

Next, an embodiment will be described in which, when a plurality of users logs in to the image processing device 1, a state of other users can be grasped. FIG. 12 is a block diagram exemplifying a functional configuration of a main control unit 130 that realizes such an embodiment. As illustrated in FIG. 12, the main control unit 130 includes a login user DB 136, a logoff processing unit 137, and an instruction management DB 138 in addition to the configuration illustrated in FIG. 5.

The login user DB 136 stores user information of users whose login is authenticated by the login processing unit 132 and who logged in. The logoff processing unit 137 deletes user information of a user who inputs a logoff instruction from the login user DB 136 according to the logoff instruction inputted from the user.

The instruction management DB 138 stores instruction information inputted from the instruction processing unit 133 in association with identification information identifying the instruction and a user ID of a user who inputs the instruction. When the instruction stored in the instruction management DB 138 is executed, the instruction processing unit 133 deletes the corresponding instruction information from the instruction management DB 138.

The screen information generation unit 135 adds screen information for grasping the state of other users and/or the like to the aforementioned operation screen information. Specifically, first, the screen information generation unit 135 acquires user information of other users who log in besides a user who uses the mobile terminal 2 on which the screen information is displayed, from the login user DB 136. Then, the screen information generation unit 135 generates operation screen information with login information, in which screen information for displaying the other users who logged in is added to the operation screen information, on the basis of the acquired user information.

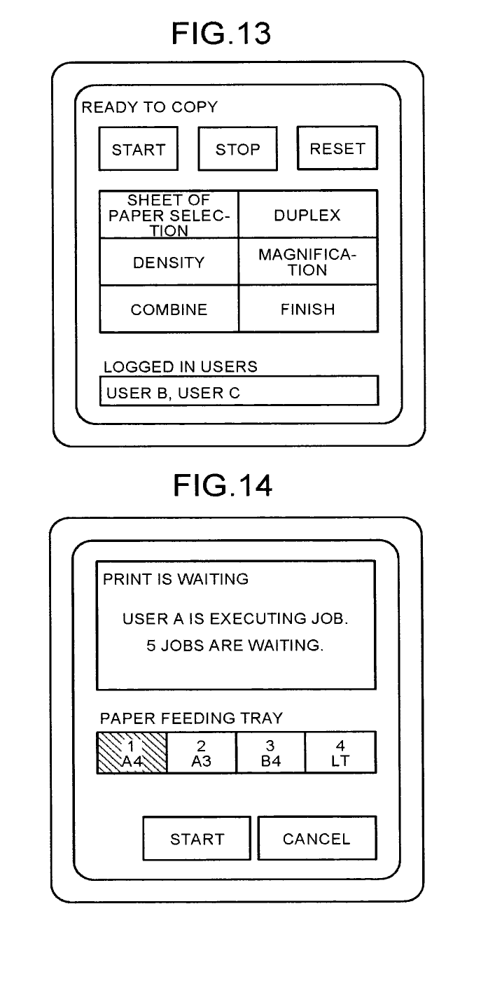

FIG. 13 is a diagram exemplifying an operation screen displayed on the mobile terminal 2 used by a user A whose login is authenticated. As illustrated in FIG. 13, for example, in addition to an operation screen to perform a copy function, it is displayed that a user B and a user C besides the user A logged in to the image processing device 1. On the other hand, it is displayed that the user A newly logged in on respective screens of the mobile terminals 2 used by the user B and the user C who already logged in. A user who logged in through a login screen displayed on the display panel 113 may be displayed in a manner different from that of other users who logged in from the mobile terminal 2.

Further, the screen information generation unit 135 acquires instruction information waiting to be processed from the instruction management DR 138 and generates operation screen information with waiting information, in which screen information for displaying a state of instructions (jobs) waiting to be processed is added to the operation screen information. FIG. 14 is a diagram exemplifying an execution screen displayed on the mobile terminal 2 used by the user B whose login is authenticated. As illustrated in FIG. 14, in an operation screen when processing is performed according to a print request, it is displayed that a print job of the user B is waiting because the other user A is executing a job. Further, as illustrated in FIG. 14, the number of waiting jobs (for example, 5) is displayed.

Here, a case in which the login state of other users and the like are displayed on the LCD 60 which is the display unit of the mobile terminal 2 is described as an example. However, when there is a user who performs an operation through the display panel 113 of the image processing device 1, the login state and/or the like of other users and/or the like may be displayed on the display panel 113 which is the display unit of the image processing device 1.

By such a configuration, the user who logs in to the image processing device 1 can grasp the usage situation of users such as the login state of other users and the state of the jobs on the operation screen, so that when there are many users who logged in and many waiting jobs, it is possible to further improve the security of the printed matter by refraining from issuing an output permission request until the number of users who logged in and the number of waiting jobs reduce.

In the embodiment described above, a case is assumed in which the screen information generation unit 135 generates the common content of operation screen information to be displayed by the terminals regardless of users whose login is authenticated. However, the screen information generation unit 135 may generate operation screen information depending on each user whose login is authenticated. When the screen information generation unit 135 generates operation screen information depending on a user, for example, the user information outputted from the terminal to the login processing unit 132 includes a use history (for example, a history of functions used by the user and a history of various setting information) and the screen information generation unit. 135 generates the operation screen information based on the use history.

Specifically, for example, the screen information generation unit 135 generates the operation screen information of the image processing device 1 which displays a function used last time by the user (for example, copy function) and setting information to use the function (for example, sheet of paper size and magnification ratio) from the use history included in the user information.

In this case, the instruction reception unit 233 acquires used functions of the image processing device 1 and setting information to use the functions as the use history from the received instruction information and stores the use history in the user history DB not illustrated. Then, for example, the user information transmission unit 232 transmits a user history stored in the user history DB to the login processing unit 132 along with the user information.

Further, in the embodiment described above, the image processing device 1 records an execution history of operation instructions transmitted through the operation screen of the mobile terminal 2 and when the connection with the mobile terminal 2 is disconnected due to a communication failure or the like, the image processing device 1 causes the mobile terminal 2 to display the execution history of the operation instructions when the connection is resumed. Thereby, the user can check the presence or absence of operation instructions or the like that are not transmitted normally and not executed due to disconnection between the mobile terminal 2 and the image processing device.

Further, in the embodiment described above, when only one user logged in to the image processing device 1, the image processing device 1 may cause the operation screen displayed on the mobile terminal 2 and the operation screen displayed on the display panel 113 to be able to operate together. Thereby, the usability of the operation screen is improved.

Further, in the embodiment described above, a case is described as an example in which the operation screen is displayed on the mobile terminal 2 after logging in to the image processing device 1. However, when one mobile terminal 2 is not used by a plurality of users and the user can be identified by only the terminal ID, the login process to the image processing device 1 is not essential.

Further, in the embodiment described above, a case is described as an example in which the display panel 113 fixed to the image processing device 1 and the LCD 60 of the mobile terminal 2 are used as an operation panel for the image processing device 1. In addition to the above, a portable terminal detachably attached to the image processing device 1 may be used as the operation panel. The state in which the portable terminal is attached to the image processing device 1 indicates a state, for example, in which the portable terminal is wire-connected by USB or the like, and the state in which the portable terminal is detached from the image processing device 1 indicates a state, for example, in which the portable terminal is wirelessly connected by short range radio communication, wireless LAN communication, or the like.

When a print request is issued through an operation screen displayed on such a portable terminal and the portable terminal is attached to the image processing device 1, the instruction processing unit 133 executes printout onto a sheet of paper or the like based on the print job requested to be printed in the same manner as when a print request is issued from the display panel 113. On the other hand, when the portable terminal is detached from the image processing device 1, the instruction processing unit 133 spools the print job requested to be printed in the image processing device 1 in the same manner as when a print request is issued from the mobile terminal 2.

In the same manner as in the case of the mobile terminal 2, even when the portable terminal is detached from the image processing device 1, if the distance between the portable terminal and the image processing device 1 is within a predetermined range, the print job corresponding to a print request from the portable terminal may be printed out without being spooled.

According to an embodiment, it is possible to improve security of printed matter of an image processing device that can be operated by a plurality of users in parallel.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device that includes an operation unit and is able to receive a plurality of operation instructions in parallel from the operation unit and a portable information processing terminal, the image processing device comprising:
an instruction processing unit that executes processing according to the received operation instructions,
wherein the instruction processing unit,
when the operation instruction is a predetermined instruction generated by an operation to the operation unit included in the image processing device, executes predetermined processing according to the predetermined instruction,
when the operation instruction is a predetermined instruction generated by an operation to the information processing terminal, stores the predetermined instruction in a storage medium of the image processing device, and
when the operation instruction is a processing execution permission instruction that permits predetermined processing, executes the predetermined processing according to the predetermined instruction corresponding to the processing execution permission instruction among the predetermined instructions stored in the storage medium.

2. The image processing device according to claim 1, wherein
the processing execution permission instruction is outputted when the information processing terminal where an operation to generate the predetermined instruction corresponding to the processing execution permission instruction is performed is within a predetermined range from the image processing device.

3. The image processing device according to claim 1, wherein
the processing execution permission instruction is outputted when the processing execution permission instruction is generated by an instruction generation unit that generates the processing execution permission instruction.

4. The image processing device according to claim 3, wherein
the processing execution permission instruction is outputted when the processing execution permission instruction is generated by the instruction generation unit included in the information processing terminal where an operation to generate the predetermined instruction corresponding to the processing execution permission instruction is performed.

5. The image processing device according to claim 3, wherein
the processing execution permission instruction is outputted when the processing execution permission instruction is generated by the instruction generation unit included in the image processing device.

6. The image processing device according to claim 1, wherein
the processing execution permission instruction is outputted when the information processing terminal where an operation to generate the predetermined instruction corresponding to the processing execution permission instruction is performed is authenticated by the image processing device.

7. The image processing device according to claim 1, wherein
when the operation instruction is a predetermined instruction generated by an operation to the information processing terminal and the information processing terminal is within a predetermined range from the image processing device, the instruction processing unit executes the predetermined processing according to the predetermined instruction.

8. The image processing device according to claim 1, further comprising:
a screen information generation unit that generates screen information to be displayed on a display unit of the image processing device or the information processing terminal, which is used by a user who performs an operation directed to the image processing device,
wherein the screen information generation unit generates the screen information indicating a usage situation of other users besides the user, who perform an operation directed to the image processing device.

9. An instruction processing method of an image processing device that includes an operation unit and is able to receive a plurality of operation instructions in parallel from the operation unit and a portable information processing terminal, the instruction processing method comprising:
when the received operation instruction is a predetermined instruction generated by an operation to the operation unit included in the image processing device, executing predetermined processing according to the predetermined instruction;
when the operation instruction is a predetermined instruction generated by an operation to the information processing terminal, storing the predetermined instruction in a storage medium of the image processing device; and
when the operation instruction is a processing execution permission instruction that permits predetermined processing, executing the predetermined processing according to the predetermined instruction corresponding to the processing execution permission instruction among the predetermined instructions stored in the storage medium.

10. A computer program product comprising a non-transitory computer-readable medium containing an instruction processing program of an image processing device that includes an operation unit and is able to receive a plurality of operation instructions in parallel from the operation unit and a portable information processing terminal, the instruction processing program causing a computer to perform:
when the received operation instruction is a predetermined instruction generated by an operation to the operation unit included in the image processing device, executing predetermined processing according to the predetermined instruction;
when the operation instruction is a predetermined instruction generated by an operation to the information processing terminal, storing the predetermined instruction in a storage medium of the image processing device; and
when the operation instruction is a processing execution permission instruction that permits predetermined processing, executing the predetermined processing according to the predetermined instruction corresponding to the processing execution permission instruction among the predetermined instructions stored in the storage medium.
